(19) United States
(12) Patent Application Publication
(10) Pub. No.: US 2016/0357399 A1
(43) Pub. Date: Dec. 8, 2016

(54) METHOD AND DEVICE FOR DISPLAYING THREE-DIMENSIONAL GRAPHICAL USER INTERFACE SCREEN

(71) Applicant: Samsung Electronics Co., Ltd., Suwon-si (KR)

(72) Inventors: Seung-ho SHIN, Suwon-si (KR); Seon-ho HWANG, Yongin-si (KR); Young-min KWAK, Suwon-si (KR); Chan-min PARK, Seoul (KR); Sang-kyung LEE, Anyang-si (KR); Hae-in CHUN, Suwon-si (KR); Jong-youb RYU, Suwon-si (KR)

(21) Appl. No.: 15/239,248

(22) Filed: Aug. 17, 2016

Related U.S. Application Data
(63) Continuation of application No. PCT/KR2015/001954, filed on Feb. 27, 2015.

(30) Foreign Application Priority Data
Feb. 27, 2014 (KR) 10-2014-0023708
Dec. 8, 2014 (KR) 10-2014-0175379

(51) Int. Cl. G06F 3/0481; G06T 15/20; G06F 3/0488; G06F 3/01; G06F 3/0482

(52) U.S. Cl. CPC G06F 3/04815; G06F 3/013; G06F 3/0482; G06F 3/017; G06F 3/04817; G06F 3/04883; G06T 15/20; G06F 2203/04108

(57) ABSTRACT

A device comprises a viewpoint sensor for sensing a user's viewpoint; a rendering viewpoint determination unit for determining a rendering viewpoint according to the sensed user's viewpoint; a rendering performing unit for rendering a three-dimensional (3D) graphical user interface (GUI) screen according to the determined rendering viewpoint; a display unit for displaying the rendered 3D GUI screen; and a controller, wherein when the user's viewpoint changes, at least one new object is additionally displayed on the 3D GUI screen.

### CROSS-REFERENCE TO RELATED APPLICATION(S)

This application is a continuation application, claiming the benefit under §365(c), of an International application filed on Feb. 27, 2015 and assigned application number PCT/KR2015/001954, which claimed the benefit of a Korean patent application filed on Feb. 27, 2014 in the Korean Intellectual Property Office and assigned Serial number 10-2014-0023708, and of a Korean patent application filed on Dec. 8, 2014 in the Korean Intellectual Property Office and assigned Serial number 10-2014-0175379, the entire disclosure of each of which is hereby incorporated by reference.

### TECHNICAL FIELD

One or more exemplary embodiments relate to a method of displaying a three-dimensional (3D) graphical user interface (GUI) screen on a device.

### BACKGROUND

Recently, many devices have provided a three-dimensional (3D) graphical user interface (GUI) screen so that users may more intuitively and conveniently use the devices.

To display a 3D GUI screen, menu objects to be displayed on a screen are rendered. Also, a result of viewing the menu objects included in the 3D GUI screen in various directions according to a rendering viewpoint may be displayed.

That is, since a range of representing the 3D GUI screen varies according to a rendering viewpoint, not only a more realistic and interesting screen may be provided to a user but also a UI can be easily expanded.

### SUMMARY

One or more exemplary embodiments include a method of displaying a three-dimensional (3D) graphical user interface (GUI) screen on a screen of a device by sensing a user's viewpoint and performing rendering according to the sensed viewpoint by using a device.

One or more exemplary embodiments include a method of displaying a 3D GUI screen according to whether new data of an application is received or according to the distance between a device and a user.

According to one or more exemplary embodiments, a method includes sensing a user's viewpoint by a device; rendering a three-dimensional (3D) graphical user interface (GUI) screen according to the sensed user's viewpoint; and displaying the rendered 3D GUI screen on a display unit of the device, wherein at least one new object is additionally displayed on the 3D GUI screen when the user's viewpoint changes.

According to the one or more of the exemplary embodiments of the present invention, a user's viewpoint may be sensed, a 3D GUI screen may be rendered according to the user's viewpoint, and then the rendered 3D GUI screen may be displayed, thereby providing a user with a more intuitive UI experience. Also, new menus or objects may be displayed in the 3D GUI screen as the user's viewpoint changes to display more menus or objects on a screen, thereby expanding an UI. Also, the 3D GUI screen may be rendered in consideration of various states of a user such as the position of the user relative to a device, the user's gesture, etc., thereby increasing the user's intuition.

Also, when an application receives new data, a menu icon corresponding to the application may be 3D rendered and a notice regarding the new data may be displayed at a side of the menu icon. Accordingly, a user may determine whether the new data is received and check the content of the new data without switching between screens.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a diagram illustrating a user who looks at a mobile device according to an exemplary embodiment;

FIG. 2 is a diagram illustrating a method of rendering objects included in a three-dimensional (3D) screen according to a user's viewpoint according to an exemplary embodiment;

FIGS. 3A to 3C are diagrams illustrating a process of adding new objects as a user's viewpoint of a displayed 3D graphical user interface (GUI) screen changes according to an exemplary embodiment;

FIGS. 4A and 4B are diagrams illustrating a process of additionally displaying new menus as a user's viewpoint of a displayed 3D GUI screen changes according to an exemplary embodiment;

FIG. 5 is a diagram illustrating a process of determining a rendering viewpoint in consideration of the position of a user relative to a device according to an exemplary embodiment;

FIG. 6 is a diagram illustrating a process of changing and limiting a rendering viewpoint according to a change in a user's viewpoint according to an exemplary embodiment;

FIG. 7 is a diagram illustrating a method of displaying a 3D GUI screen in response to a user's gesture, according to an exemplary embodiment;

FIG. 8 is a diagram illustrating an interaction of an object in a displayed 3D GUI screen with respect to a user's touch input, according to an exemplary embodiment;

FIG. 9 is a block diagram of a device that performs a method of displaying a 3D GUI screen according to a user's viewpoint, according to an exemplary embodiment;

FIGS. 10 to 12 are flowcharts of methods of displaying a 3D GUI screen according to a user's viewpoint, according to exemplary embodiments;

FIG. 13 is a diagram illustrating displaying a notice regarding a new message at a side of a 3D menu icon when the new message is received, according to an exemplary embodiment;

FIG. 14 is a diagram illustrating displaying a notice regarding a new message at a side of a 3D menu icon when the new message is received, according to another exemplary embodiment;

FIG. 15 is a flowchart illustrating a method of displaying a notice regarding new data at a side of a 3D menu icon when the new data is received, according to an exemplary embodiment;

FIG. 16 is a flowchart illustrating a method of displaying a notice regarding new data at a side of a 3D menu icon when the new data is received, according to another exemplary embodiment;

FIGS. 17A and 17B are diagrams illustrating a full content of a new message displayed when a notice regarding the new message displayed at a side of a 3D menu icon is selected, according to an exemplary embodiment;

FIG. 18 is diagram illustrating a preview displayed when a notice regarding a new message displayed at a side of a 3D menu icon is selected, according to an exemplary embodiment;

FIGS. 19 and 20 are flowcharts illustrating methods of selecting a notice regarding a new message displayed at a side of a 3D menu icon, according to exemplary embodiments;

FIGS. 21A to 21C are diagrams illustrating a method of expanding a 3D menu icon and selecting a notice regarding new data displayed at a side of the 3D menu icon, according to an exemplary embodiment;

FIG. 22 is a flowchart illustrating a method of expanding a 3D menu icon and selecting a notice regarding new data displayed at a side of the 3D menu icon, according to an exemplary embodiment;

FIG. 23 is a block diagram illustrating a mobile device according to an exemplary embodiment;

FIGS. 24A and 24B are diagrams illustrating a method of changing a method of displaying a menu icon based on a distance between a mobile device and a user, according to an exemplary embodiment;

FIG. 25 is a flowchart illustrating a method of changing a method of displaying a menu icon based on the distance between a mobile device and a user, according to another exemplary embodiment; and

FIG. 26 is a block diagram illustrating a mobile device according to another exemplary embodiment.

### DETAILED DESCRIPTION

According to one or more exemplary embodiments, a method includes sensing a user's viewpoint by a device; rendering a three-dimensional (3D) graphical user interface (GUI) screen according to the sensed user's viewpoint; and displaying the rendered 3D GUI screen on a display unit of the device, wherein at least one new object is additionally displayed on the 3D GUI screen when the user's viewpoint changes.

Reference will now be made in detail to embodiments, examples of which are illustrated in the accompanying drawings, wherein like reference numerals refer to like elements throughout. To more clearly explain exemplary embodiments set forth herein, matters that are widely known to those of ordinary skill in the art to which these embodiments belong will not be described in detail below. In this regard, the present embodiments may have different forms and should not be construed as being limited to the descriptions set forth herein. Accordingly, the exemplary embodiments are merely described below, by referring to the figures, to explain aspects of the present description.

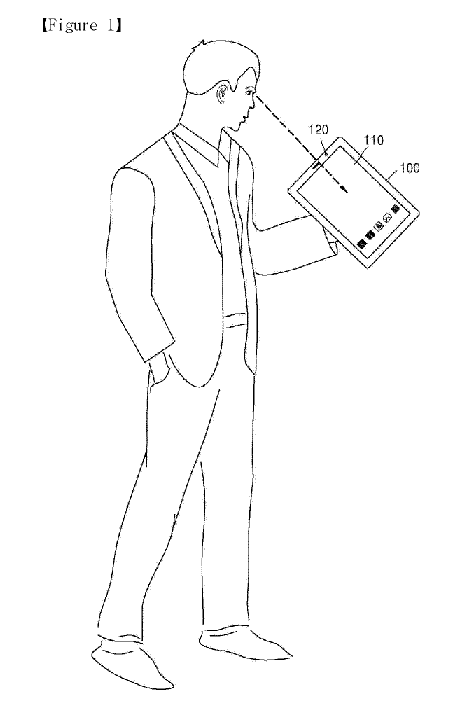

FIG. 1 is a diagram illustrating a user 10 who looks at a mobile device 100 according to an exemplary embodiment. Referring to FIG. 1, the user 10 looks at a display unit 110 of the mobile device 100. A three-dimensional (3D) graphical user interface (GUI) screen is displayed on the display unit 110 of the mobile device 100. The mobile device 100 includes a viewpoint sensor 120, e.g., a camera. The viewpoint sensor 120 senses a viewpoint 11 of the user 10. The viewpoint sensor 120 may be a color camera that is generally installed in a tablet personal computer (PC) or a depth camera capable of measuring a distance to an object.

The mobile device 100 renders the 3D GUI screen according to the viewpoint 11 of the user 10 sensed by the viewpoint sensor 120 and displays the rendered 3D GUI screen on the display unit 110. That is, the mobile device 100 determines a rendering viewpoint in a graphic pipeline according to the viewpoint 11 of the user 10 sensed by the viewpoint sensor 120, and renders the 3D GUI screen.

In this case, the viewpoint 11 of the user 10 that has an influence on determining a rendering viewpoint of the 3D GUI screen means a direction of the eyes of the user 10 who looks at the display unit 110. In detail, the viewpoint 11 of the user 10 may be understood as an angle formed by the display unit 110 and the direction of the eyes of the user 10.

Although FIG. 1 illustrates the mobile device 100 as a tablet PC, the mobile device 100 may be a notebook computer, or a smartphone. Exemplary embodiments are, however, not limited to the mobile device 100 and are applicable to a desktop PC, or a television (TV), or the like.

A gyrosensor included in the mobile device 100 may be used solely or together with a camera to sense the viewpoint 11 of the user 10.

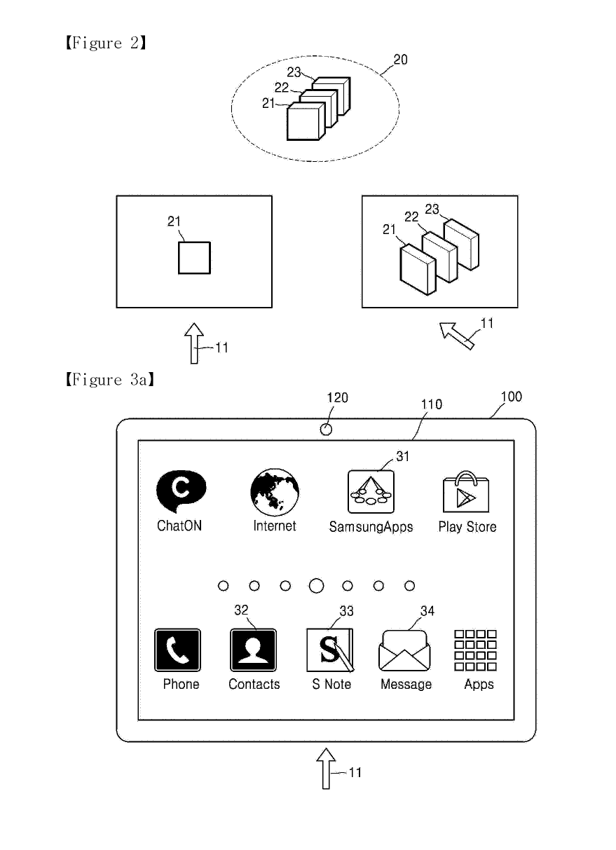

FIG. 2 is a diagram illustrating a method of rendering objects included in a 3D screen according to a user's viewpoint 11, according to an exemplary embodiment. Referring to FIG. 2, three objects 21 to 23 are arranged in a line in a 3D world 20.

In FIG. 2, a lower left diagram shows a state in which the user's viewpoint 11 is headed for the front of a display unit 110a. The user's viewpoint 11 is sensed and a rendering viewpoint is determined based on the sensed user's viewpoint 11. Since the user's viewpoint 11 is headed for the front of the display unit 110a, the rendering viewpoint is determined to be headed for the front of the 3D world 20 and then the 3D GUI screen is rendered according to the rendering viewpoint. Thus, only the foremost object 21 among the three objects 21 to 23 arranged in a line is displayed on a screen and the other two objects 22 and 23 are hidden by the foremost object 21 and are not seen on the screen.

In FIG. 2, a lower right diagram shows a state in which the user's viewpoint 11 is toward the display unit 110b in a right diagonal direction. Thus, a rendering viewpoint is also determined to be toward the three objects 21 to 23 in the 3D space 20 in the right diagonal direction. Thus, all of the three objects 21 to 23 arranged in a line are displayed on the screen while being partially hidden by different objects.

As described above, various 3D screens may be displayed according to the user's viewpoint 11 by sensing the user's viewpoint 11, determining a rendering viewpoint based on the user's viewpoint 11, and rendering a 3D screen.

In particular, as shown in the lower left drawing of FIG. 2 illustrating that only the foremost object 21 is displayed on the screen and the lower right drawing of FIG. 2 illustrating all of the three objects 21 to 23 are displayed on the screen, a new object that cannot be seen from a previous viewpoint may be displayed on the screen when the user's viewpoint 11 changes.

Thus, a user interface (UI) screen including various menus and objects may be configured such that new menus and objects are additionally displayed on a screen as a user's viewpoint changes, thereby expanding a UI. Exemplary embodiments thereof will be described in detail with reference to the drawings below.

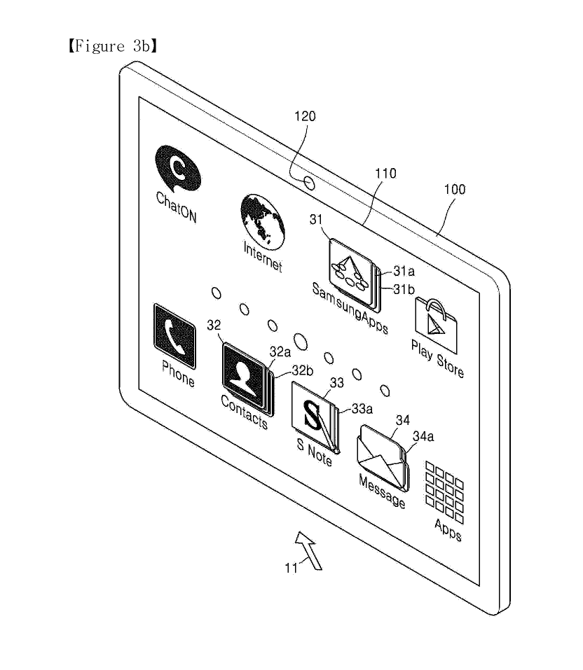

FIGS. 3A to 3C are diagrams illustrating a process of adding new objects as a user's viewpoint of a displayed 3D GUI screen changes according to an exemplary embodiment.

Referring to FIG. 3A, a user's viewpoint 11 is toward a display unit 110 of a mobile device 100. A viewpoint sensor 120 included in the mobile device 100 senses the user's viewpoint 11. Then, a 3D GUI screen rendered according to the user's viewpoint 11 is displayed on the display unit 110. Referring to FIG. 3A, since the user's viewpoint 11 is toward the front of the display unit 110, all of menu icons such as a ‘SamsungApps’ icon 31, a ‘Contacts’ icon 32, an ‘S Note’ icon 33, and a ‘Message’ icon 34 are rendered according to a front rendering viewpoint.

Referring to FIG. 3B, the user's viewpoint 11 changes to be toward the display unit 110 in a right diagonal direction, compared to that in FIG. 3A. As the user's viewpoint 11 changes as described above, the rendering viewpoint is also changed. Thus, new objects 31a, 31b, 32a, 32b, 33a, and 34a that are displayed behind the menu icons 31 to 34 and are thus not seen from the front of the display unit 110 are displayed on the screen. The new objects 31a, 31b, 32a, 32b, 33a, and 34a may be menus equivalent or subordinate to the menu icons 31 to 34, respectively.

For example, the objects 31a and 31b displayed behind the ‘SamsungApps’ icon 31 may correspond to applications manufactured and distributed by Samsung. The objects 32a and 32b displayed behind the ‘Contacts’ icon 32 may correspond to ‘Favorites’ and ‘Recents’ which are menus subordinate to the ‘Contacts’ icon 32. Similarly, objects displayed behind the ‘S Note’ icon 33 and the ‘Message’ icon 34 may correspond to menus equivalent or subordinate to the ‘S Note’ icon 33 and the ‘Message’ icon 34.

Although FIG. 3B illustrates that each of new menus or objects to be added as the user's viewpoint 11 changes is displayed behind a corresponding menu icon to have a size and a form that are the same as those of the corresponding menu icon among the menu icons displayed on the screen before the user's viewpoint 11 changes, the new menus or objects may be displayed to have various sizes and forms. In particular, the size and form of an icon may be determined so that the features of a menu to which the icon belongs may be appropriately displayed.

Even if the icons behind the menu icons 31 to 34 are hidden by other icons and are thus partially displayed, the icons may be selected according to a user's touch input. That is, a UI may be provided to interact with every possible user's viewpoint.

Since the objects behind the menu icons 31 to 34 are partially seen, a user would have difficulties in identifying menus to which the objects belong by simply seeing the partially displayed objects. To solve this problem, when new icons are additionally displayed on the screen as the user's viewpoint 11 changes, the names of menus corresponding to the new icons may be displayed together with the icons or the name of a menu corresponding to an icon may be displayed when a user touches the icon. In the case of an object that is partially hidden by another object among objects in a 3D GUI screen, the name of the object may be originally displayed next to the object or displayed when a user touches the partially hidden object.

Referring to FIG. 3C, the user's viewpoint 11 is moved to the right, compared to that in FIG. 3B. As the user's viewpoint 11 is moved to the right, the rendering viewpoint is also moved to the right. As a result, as illustrated in FIG. 3C, the distances between the menu icons 31 to 34 and the icons behind the menu icons 31 to 34 increase. That is, since the rendering viewpoint is also changed according to the user's viewpoint 11 and thus relative positions of the objects displayed on the screen change. As described above, as the user's viewpoint 11 changes, the positions of the objects are displayed as if a real 3D world is seen, and thus, a user may more intuitively experience use of the mobile device 100.

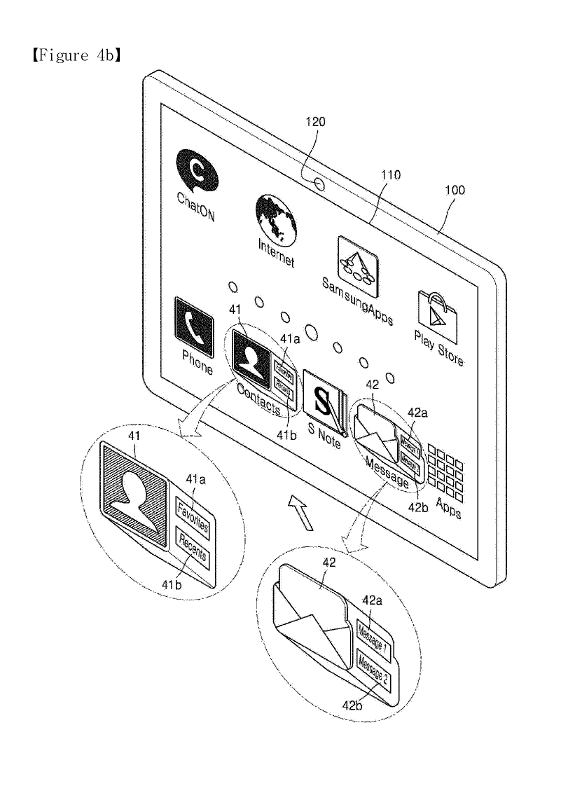

Although the rendering viewpoint is changed as the user's viewpoint changes, the rendering viewpoint may be prevented from being changed when the user's viewpoint changes beyond a predetermined range, as will be described in detail with reference to FIG. 6 below.

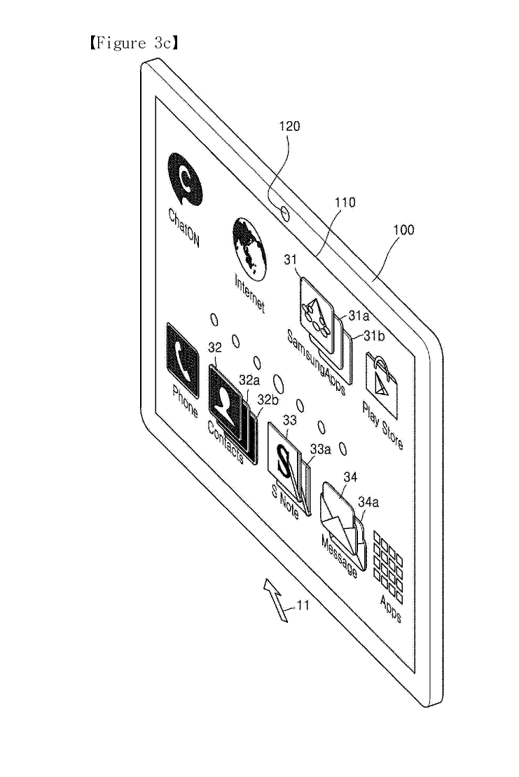

FIGS. 4A and 4B are diagrams illustrating a process of additionally displaying new menus as a user's viewpoint 11 of a displayed 3D GUI screen changes according to an exemplary embodiment.

Referring to FIG. 4A, the user's viewpoint 11 is headed for the front of a display unit 110 of a mobile device 100. A viewpoint sensor 120 included in the mobile device 100 senses the user's viewpoint 11. A 3D GUI screen rendered according to the user's viewpoint 11 is displayed on the display unit 110. Referring to FIG. 4A, since the user's viewpoint 11 is toward the front of the display unit 110, all of menu icons including a ‘Contacts’ icon 41 and a ‘Message’ icon 42 are rendered according to a front rendering viewpoint.

Referring to FIG. 4B, the user's viewpoint 11 changes to be toward the display unit 110 in a right diagonal direction, compared to that in FIG. 4A. As the user's viewpoint 11 changes as described above, a rendering viewpoint is also changed. Thus, objects 41a, 41b, 42a, and 42b located on side surfaces of the menu icons 41 and 42 that are not seen from the front view of the display unit 110 are additionally displayed on the screen.

That is, objects corresponding to menus equivalent or subordinate to the menu icons 41 and 42 are displayed on the side surfaces of the menu icons 41 and 42. Specifically, a ‘Favorites’ icon 41a and a ‘Recents’ icon 41b are displayed on a side surface of the ‘Contacts’ icon 41, and a ‘Message 1’ icon 42a and a ‘Message 2’ icon 42b corresponding to a plurality of stored messages are displayed on a side surface of the ‘Message’ icon 42. A user may select a subordinate menu through a touch input in a state in which subordinate menus are displayed on the side surfaces of the menu icons 41 and 42 as illustrated in FIG. 4B.

Although FIG. 4B illustrates that objects corresponding to subordinate menus are displayed on right side surfaces of the menu icons 41 and 42, these objects may be displayed on lower or upper side surfaces of the menu icons 41 and 42 according to a user's viewpoint.

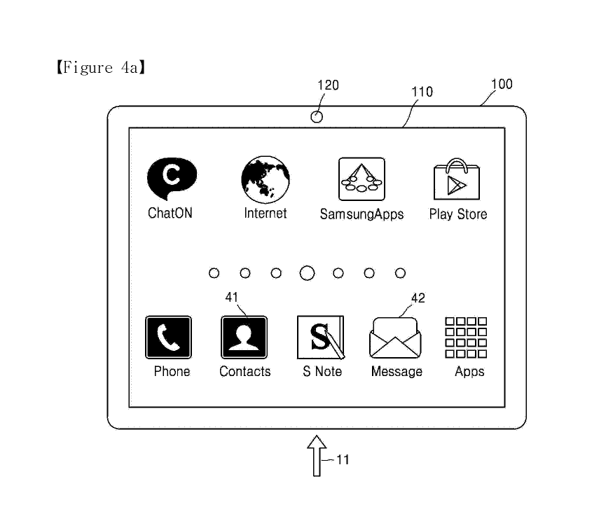

FIG. 5 is a diagram illustrating a process of determining a rendering viewpoint in consideration of the position of a user relative to a device according to an exemplary embodiment.

Referring to a left diagram 50A and a right diagram 50B of FIG. 5, the angle formed by the direction of the eyes of a user 10 and the mobile device 100 is the same but the distance from the mobile device 100 to the user 10 is different (i.e., the distance is d1 in the left diagram 50A and is d2 in the right diagram 50B).

Although the angle formed by the direction of the eyes of the user 10 and the mobile device 100 is the same as described above, a rendering viewpoint may vary according to the distance between the mobile device 100 and the user 10. This is because a perspective view varies according to the distance from the mobile device 100 to the user 10.

Thus, a rendering viewpoint may be determined in consideration of both the angle formed by the direction of the eyes of the user 10 and the display unit 110 of the mobile device 100 and the distance from the mobile device 100 to the user 10, thereby providing a more realistic 3D screen.

FIG. 6 is a diagram illustrating a process of changing and limiting a rendering viewpoint according to a change in a user's viewpoint according to an exemplary embodiment.

As described above, a rendering viewpoint is changed as the user's viewpoint changes. However, when a screen corresponding to a rendering viewpoint that is beyond a predetermined range need not be displayed in terms of a UI design, a range of changing the rendering viewpoint may be limited to a predetermined range. That is, when the user's viewpoint is changed beyond the predetermined range, changing of the rendering viewpoint may be limited.

Referring to FIG. 6, when a viewpoint of a user 10 who looks at the mobile device 100 changes from a viewpoint 11a to a viewpoint 11b and finally to a viewpoint 11c, the rendering viewpoint should be also changed. However, the rendering viewpoint may be set to be maintained to correspond to the viewpoint 11b, even if the viewpoint of the user 10 passes by the viewpoint 11b. Specifically, the rendering viewpoint is also changed when the viewpoint of the user 10 changes from the viewpoint 11a to the viewpoint 11b, but the rendering viewpoint corresponding to the viewpoint 11b is maintained when the viewpoint of the user 10 changes from the viewpoint 11b to the viewpoint 11c.

That is, the rendering viewpoint is controlled to be changed according to a change in the angle formed by the display unit 110 of the mobile device and the direction of the eyes of the user 10 and not to be changed when the change in the angle is beyond a predetermined range.

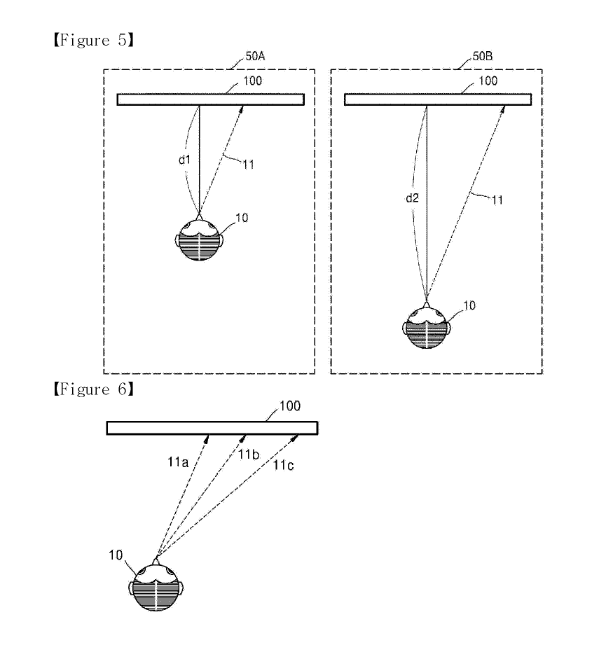

FIG. 7 is a diagram illustrating a method of displaying a 3D GUI screen in response to a user's gesture input according to an exemplary embodiment. The previous embodiments described above are related to sensing a user's viewpoint and changing a rendering viewpoint according to the user's viewpoint. In contrast, in the exemplary embodiment of FIG. 7, a user's gesture input is reflected in determining a rendering viewpoint.

Referring to FIG. 7, when a user inputs a gesture of moving his/her hand from right to left in front of a display unit 110 of a mobile device 100, a viewpoint sensor 120 embodied as a camera senses the gesture input. Then, the mobile device 100 renders a 3D GUI screen by changing a rendering viewpoint according to the gesture input and displays the rendered 3D GUI screen on the display unit 110. Referring to FIG. 7, new objects 71a, 71b, 72a, and 72b corresponding to menus equivalent or subordinate to menu icons 71 and 72 are additionally displayed behind the menu icons 71 and 72 as a result of inputting the user's gesture.

As described above, a 3D GUI screen may be manipulated by a user in various ways by reflecting the user's gesture input in determining a rendering viewpoint.

A rendering viewpoint may be determined either in consideration of both a user's viewpoint and the user's gesture input or based only the user's gesture input.

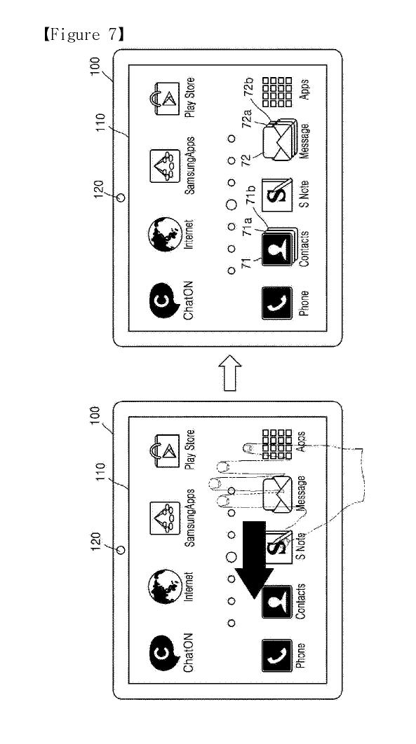

FIG. 8 is a diagram illustrating an interaction of an object in a displayed 3D GUI screen with respect to a user's touch input according to an exemplary embodiment.

In FIG. 8, an upper diagram shows a state in which a user's viewpoint is toward the front of a mobile device 300. Thus, only a front surface of a menu icon 81 displayed on a display unit 310 of a mobile device 300 is seen. When the user's viewpoint is moved to the right, side surfaces of the menu icon 81 are displayed on the display unit 310 of the mobile device 300 as shown in a lower diagram of FIG. 8.

As described above, the menu icon 81 is rotated about an axis 82 when the user touches a corner of the menu icon 81 in a state in which a rendering viewpoint is changed as the user's viewpoint changes. That is, interactions of objects are determined according to a screen corresponding to the user's current viewpoint. Accordingly, the user is able to more intuitively manipulate a UI.

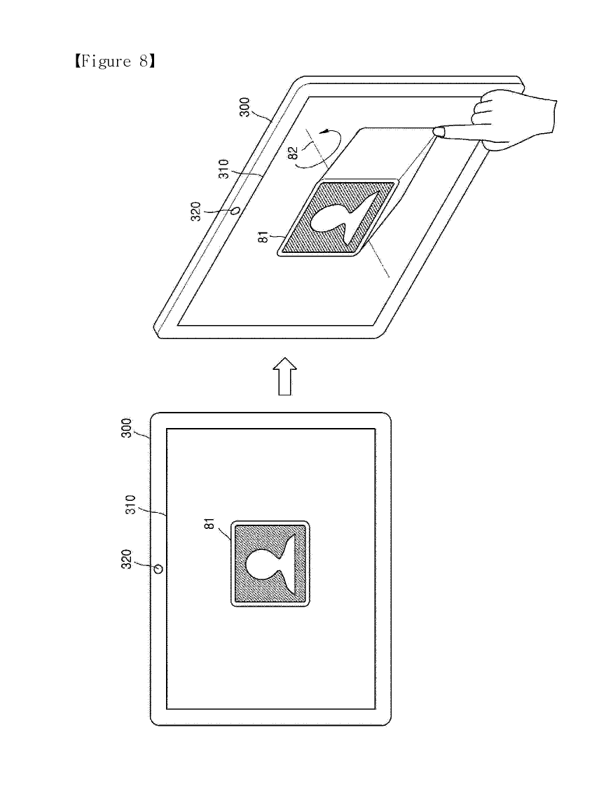

FIG. 9 is a block diagram of a device 100 configured to perform a method of displaying a 3D GUI screen according to a user's viewpoint according to an exemplary embodiment. Referring to FIG. 9, according to an exemplary embodiment, the device 100 may include a display unit 110, a controller 130, a viewpoint sensor 120, a rendering viewpoint determination unit 141, and a rendering performing unit 142.

The display unit 110 displays a 3D GUI screen. Specifically, the display unit 110 receives a 3D GUI screen rendered by the rendering performing unit 142 via the controller 130 and displays the 3D GUI screen on a screen thereof. Also, the display unit 110 may receive a touch input for selecting a menu or an object in the 3D GUI screen from the user.

The viewpoint sensor 120 may sense a viewpoint from which the user looks at the display unit 110, and transmits a result of sensing the user's viewpoint to the controller 130 and the rendering viewpoint determination unit 141. The viewpoint sensor 120 may be a color camera or a depth camera. The viewpoint sensor 120 may sense the user's viewpoint by measuring an angle formed by the direction of the eyes of the user who looks at the display unit 110 and the display unit 110.

When the viewpoint sensor 120 is a camera, the viewpoint sensor 120 may receive the user's gesture input and transmit the user's gesture input to the rendering viewpoint determination unit 141 so that the user's gesture input may be reflected in determining a rendering viewpoint.

The controller 130 controls operations of all of the components included in the device 100. In particular, the controller 130 controls a series of processes in which the rendering viewpoint determination unit 141 determines a rendering viewpoint according to the user's viewpoint sensed by the viewpoint sensor 120 and the rendering performing unit 142 renders a 3D GUI screen according to the rendering viewpoint.

The rendering viewpoint determination unit 141 determines a rendering viewpoint according to the user's viewpoint sensed by the viewpoint sensor 120. A method of determining a rendering viewpoint may be performed by equalizing the rendering viewpoint with the user's viewpoint sensed by the viewpoint sensor 120 or considering both the user's viewpoint and the position of the user.

For example, an angle formed by the direction of the eyes of the user and the display unit 110 may be measured and an angle of the rendering viewpoint may be set to be equal to the measured angle. Otherwise, a rendering viewpoint determined according to the measured angle may be compensated for by reflecting the distance from the display unit 110 to the user into the rendering viewpoint.

In addition, the sensing of the user's viewpoint and the determination of the rendering viewpoint according to the user's viewpoint may be performed by measuring the user's state such as the direction of the eyes of the user and the position of the user and using various methods based on a result of measuring the user's state.

The rendering performing unit 142 renders the 3D GUI screen according to the rendering viewpoint determined by the rendering viewpoint determination unit 141, and transmits the rendered 3D GUI screen to the controller 130. The controller 130 displays the rendered 3D GUI screen on the display unit 110.

The rendering performing unit 142 determines at least one object to be seen in the 3D GUI screen from the rendering viewpoint determined by the rendering viewpoint determination unit 141 and renders the determined at least one object. When the rendering viewpoint is changed according to a change in the user's viewpoint, the rendering performing unit 142 determines at least one new object to be added to the 3D GUI screen and renders the 3D GUI screen to which the at least one new object is added.

Although not shown, the device 100 may further include a gyrosensor and the like to be supplementarily used to sense the user's viewpoint.

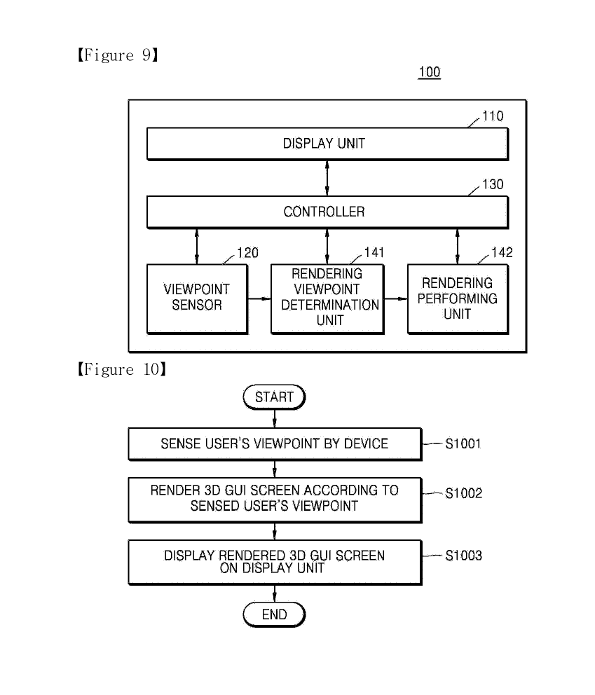

FIGS. 10 to 12 are flowcharts of methods of displaying a 3D GUI screen according to a user's viewpoint according to exemplary embodiments.

Referring to FIG. 10, in operation S1001, a device senses a user's viewpoint. The user's viewpoint may be sensed by measuring an angle formed by a direction of the eyes of the user who looks at a display unit and the display unit.

In operation S1002, a 3D GUI screen is rendered according to the sensed user's viewpoint. Then, in operation S1003, the rendered 3D GUI screen is displayed on the display unit. In this case, when the user's viewpoint changes, at least one new object may be additionally displayed on the 3D GUI screen.

Referring to FIG. 11, in operation S1101, a device senses a user's viewpoint. In operation S1102, a rendering viewpoint is determined according to the sensed user's viewpoint. The rendering viewpoint may be determined by equalizing the rendering viewpoint with the sensed user's viewpoint or considering both the sensed user's viewpoint and the position of the user.

In operation S1103, at least one object to be seen on a 3D GUI screen from the determined rendering viewpoint is determined. Specifically, at least one object to be seen on the 3D GUI screen viewed from the determined rendering viewpoint is determined. In operation S1104, the determined at least one object is rendered. Then, in operation S1105, the rendered 3D GUI screen is displayed on a display unit.

Referring to FIG. 12, in operation S1201, a device senses a user's viewpoint. In operation S1202, a 3D GUI screen is rendered according to the sensed user's viewpoint. In operation S1203, the rendered 3D GUI screen is displayed on a display unit.

In operation S1204, when the user's viewpoint changes, at least one object to be added to the 3D GUI screen is determined. Specifically, when the user's viewpoint changes, a rendering viewpoint is changed according to the changed user's viewpoint, and at least one object that cannot be seen before the rendering viewpoint is changed but is to be newly seen from the changed rendering viewpoint is determined.

In operation S1205, the 3D GUI screen is rendered according to the changed user's viewpoint. In operation S1206, the rendered 3D GUI screen is displayed on a display unit.

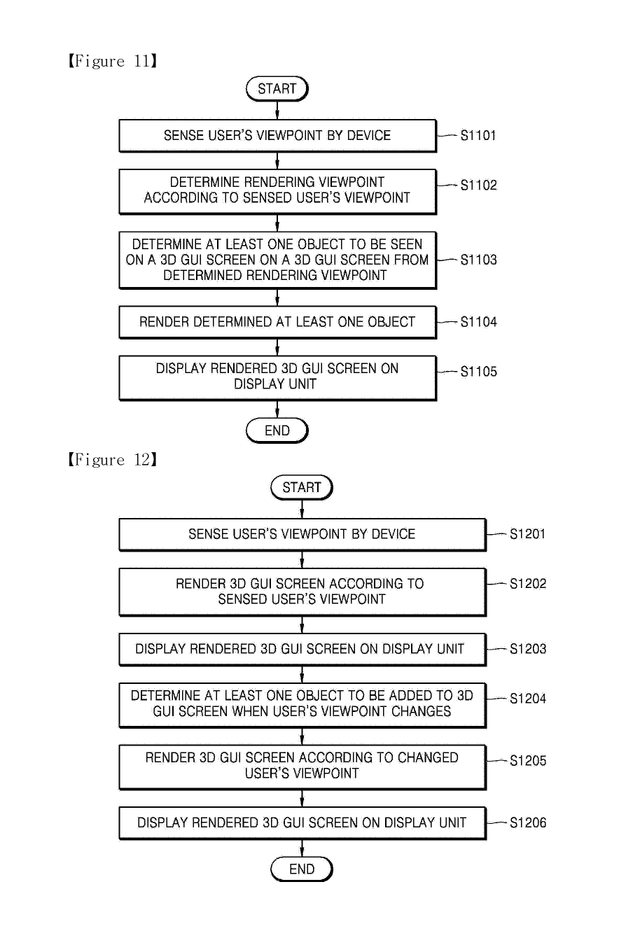

A method of three-dimensionally (3D) rendering a menu icon, the new data of which is received, and displaying a notice regarding the new data at a side of the menu icon when a mobile device according to an exemplary embodiment receives the new data will be described with reference to FIGS. 13 to 23 below.

FIG. 13 is a diagram illustrating displaying of a notice regarding a new message at a side of a 3D menu icon when the new message is received, according to an exemplary embodiment.

Referring to FIG. 13, the mobile device 100 receives a new message from a message management server 1000. The mobile device 100 determines that an application that receives new data, i.e., the new message, is a message application, and three-dimensionally (3D) renders a menu icon 1300 corresponding to the message. A notice regarding the new data is displayed at a side of the 3D rendered menu icon 1300. Referring to FIG. 13, the names of the senders of new messages are displayed in notices 1310 and 1320 regarding the new messages, respectively.

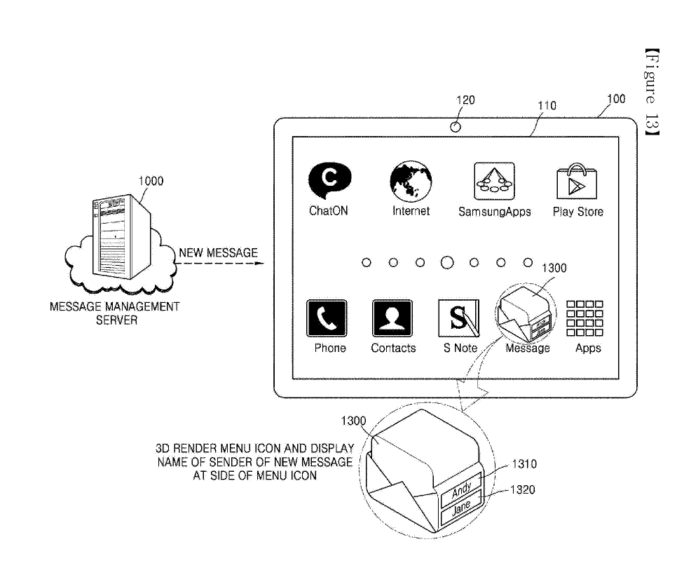

FIG. 14 is a diagram illustrating displaying of a notice regarding a new message at a side of a 3D menu icon when the new message is received, according to another exemplary embodiment.

Referring to FIG. 14, the mobile device 100 receives new messages from a message management server 1000. The mobile device 100 determines that an application that receives new data, i.e., the new messages, is a message application, and 3D renders a menu icon 1400 corresponding to the messages. Notices regarding the new messages are displayed at a side of the 3D rendered menu icon 1400. Referring to FIG. 14, contents of new messages are partially displayed on notices 1410 and 1420 regarding the new messages.

Although FIGS. 13 and 14 illustrate cases in which the name of the sender of a new message or a portion of the content of the new message are displayed in a notice regarding the new message, exemplary embodiments are not limited thereto and the notice regarding the new message may be displayed in various forms to identify the new data. For example, both the name of the sender and a portion of the content may be displayed in the notice regarding the new message.

As described above, when new data is received, a menu icon corresponding to an application that receives the new data is 3D rendered and a notice regarding the new data is displayed at a side of the 3D rendered menu icon. Thus, a user may easily determine whether the new data is received and check a brief content of the new data, etc.

Although cases in which new data is a message are described in the above exemplary embodiments, the exemplary embodiments are not limited thereto and the methods described above are applicable to various cases in which an application receives new data. For example, when the mobile device 100 receives a notice indicating an unanswered call, a menu icon of a phone may be 3D rendered and the telephone number corresponding to the unanswered call may be displayed at a side of the 3D rendered menu icon.

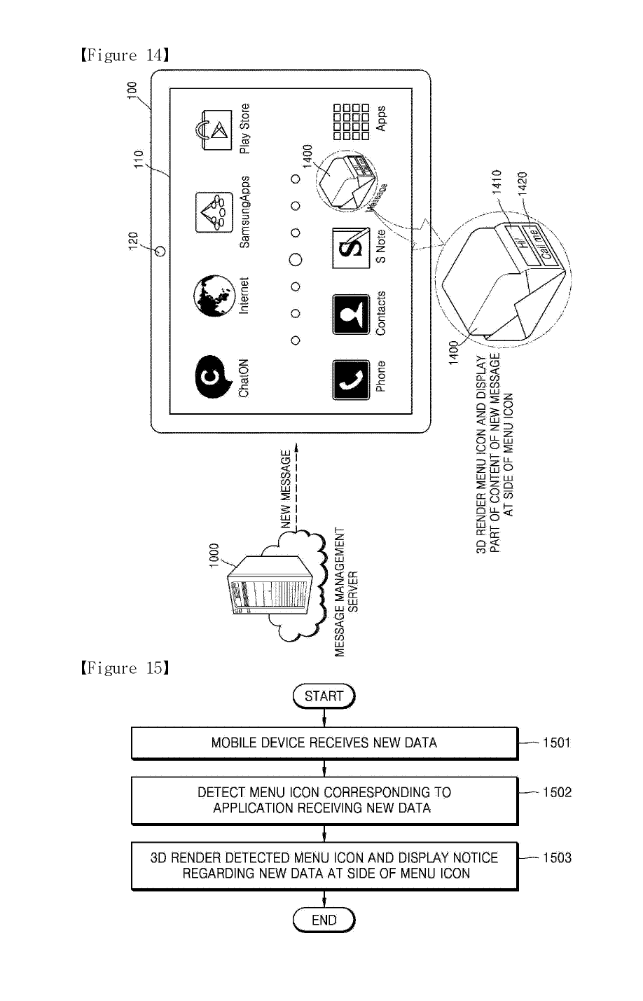

FIG. 15 is a flowchart illustrating a method of displaying a notice regarding new data at a side of a 3D menu icon when the new data is received, according to an exemplary embodiment.

Referring to FIG. 15, in operation S1501, a mobile device receives new data. In this case, the type of the new data may depend on the type of an application that receives the new data. For example, the new data may be a message when a message application receives the new data and may be a notice indicating an unanswered call when a phone application receives the new data.

In operation S1502, the mobile device detects a menu icon corresponding to the application that receives the new data. In this case, the mobile device may refer to a mapping table stored in a storage unit of the mobile device and in which applications and menu icons are mapped to each other.

In operation S1503, the mobile device 3D renders the detected menu icon and displays a notice regarding the new data at a side of the 3D menu icon. In this case, the notice regarding the new data displayed at the side of the 3D menu icon may include contents identifying the new data. That is, when the new data is, for example, a message, the notice regarding the new data may include the name of the sender of the message, a part of the content of the message, etc.

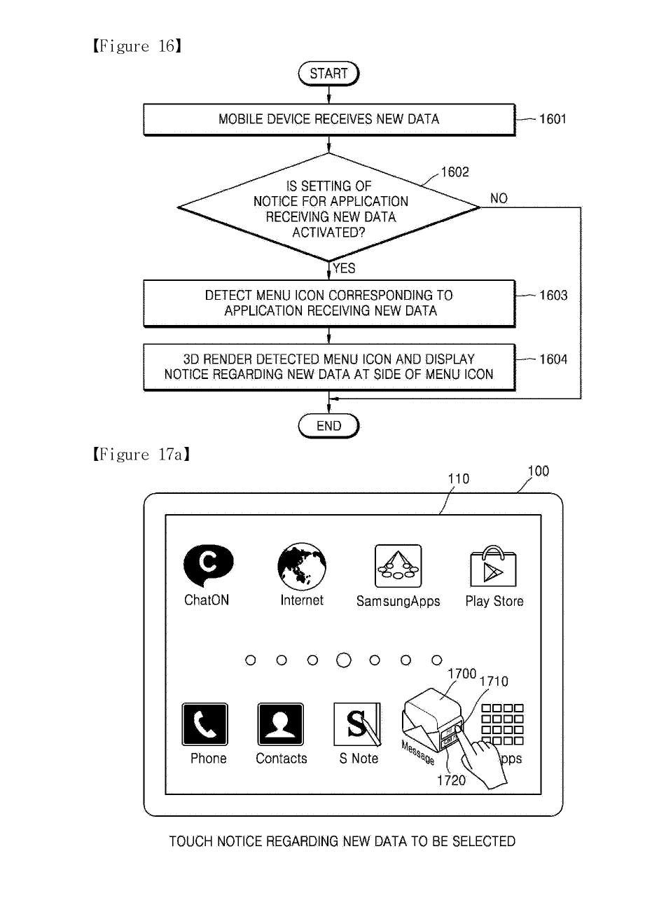

The method of FIG. 15 may be differently configured according to whether a setting for a notice of an application is activated, as will be described in detail with reference to FIG. 16 below.

FIG. 16 is a flowchart illustrating a method of displaying a notice regarding new data at a side of a 3D menu icon when the new data is received, according to another exemplary embodiment.

Referring to FIG. 16, in operation S1601, a mobile device receives new data. The type of the new data may depend on the type of an application that receives the new data. For example, the new data may be a message when a message application receives the new data or may be a notice indicating an unanswered call when a phone application receives the new data.

In operation S1602, the mobile device determines whether a setting for a notice of the application receiving the new data is activated. For example, when a message application receives the new message, the mobile device determines whether a setting for a notice of the message application is activated.

When it is determined that the setting for the notice of the application receiving the new data is activated, operation S1603 in which the mobile device detects a menu icon corresponding to the application that receives the new data is performed. However, when it is determined that the setting for the notice of the application receiving the new data is not activated, the method is ended.

In operation S1604, the mobile device 3D renders the detected menu icon and displays a notice of the new data at a side of the 3D menu icon. In this case, the notice regarding the new data displayed at the side of the 3D menu icon may include contents identifying the new data. For example, the notice regarding the new data may include the name of the sender of the message and a portion of the content of the message, etc. when the new data is a message.

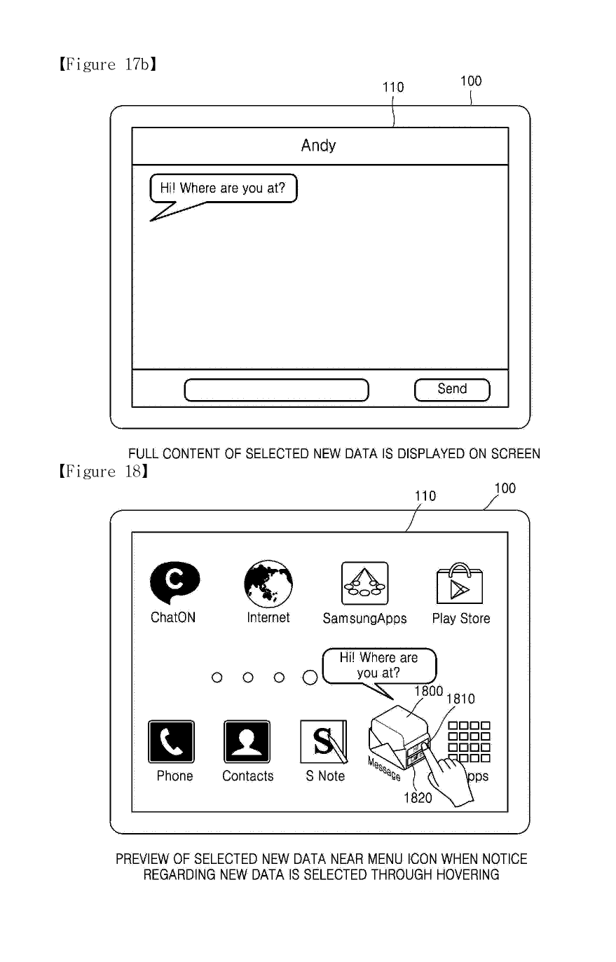

FIGS. 17A and 17B are diagrams illustrating a full content of a new message displayed when a notice regarding the new message displayed at a side of a 3D menu icon is selected, according to an exemplary embodiment.

Referring to FIG. 17A, menu icons of applications are displayed on a display unit 110 of a mobile device 100. A menu icon 1700 corresponding to a message application among the menu icons is 3D rendered and displayed, and notices 1710 and 1720 of new messages are displayed at a side of the menu icon 1700.

When a user touches and selects the notice 1710 among the notices 1710 and 1720 of the new messages displayed at the side of the menu icon 1700, a current screen is switched to a screen displaying a full content of the new message corresponding to the selected notice 1710. The mobile device 100 that displays the full content of the new message of the selected notice 1710 is illustrated in FIG. 17B.

As illustrated in FIG. 17B, when a new message is selected, a current screen may be switched to a screen displaying a full content of the new message. However, a preview of the selected new message may be also displayed so that a user may check the content of the selected new message without switching between screens.

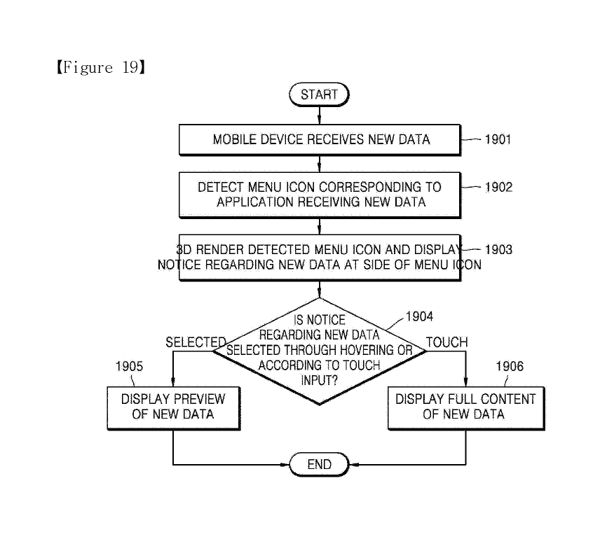

FIG. 18 is diagram illustrating a preview displayed when a notice regarding a new message displayed at a side of a 3D menu icon is selected according to an exemplary embodiment.

Referring to FIG. 18, menu icons of applications are displayed on a display unit 110 of a mobile device 100, a menu icon 1800 corresponding to a message application among the applications is 3D rendered and displayed, and notices 1810 and 1820 regarding new messages are displayed at a side of the menu icon 1800.

When a user selects a notice 1810 among the notices 1810 and 1820 regarding the new messages displayed at the side of the menu icon 1800 through hovering, a preview of the new message corresponding to the notice 1810 is displayed near the menu icon 1800. In the present description, the term ‘hovering’ should be understood as an input manner performed by approaching an object within a predetermined distance without directly touching the object. As described above, a user may view a preview of a new message by selecting a notice regarding the new message through hovering, thereby conveniently checking the content of the new message without switching between screens.

Although a method of displaying a full content of or a preview of a selected message according to whether the message is selected by touching a notice regarding the message or by hovering has been described in the above exemplary embodiment, the full content or the preview of the message may be displayed according to a duration of a touch input.

For example, a full content of a new message may be displayed as illustrated in FIG. 17B when a notice regarding the new message is touched for a short time, and a preview of the new message may be displayed as illustrated in FIG. 18 when the notice regarding the new message is touched for a long time.

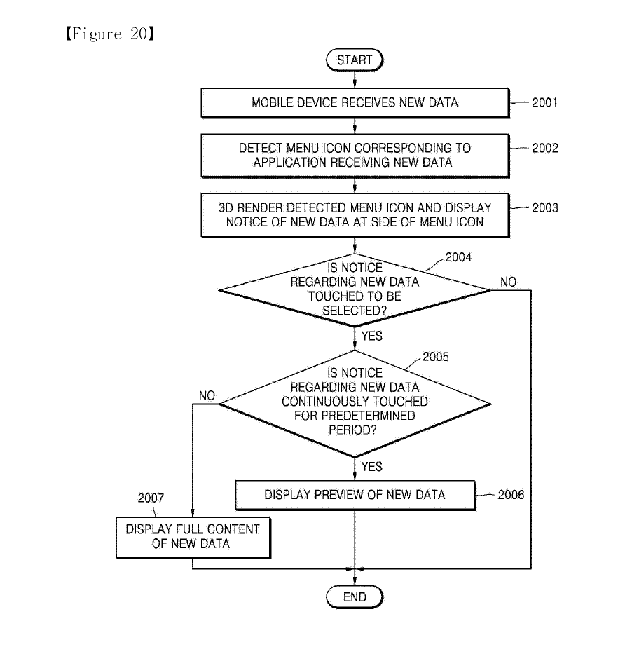

FIGS. 19 and 20 are flowcharts illustrating methods of selecting a notice regarding a new message displayed at a side of a 3D menu icon according to exemplary embodiments.

Referring to FIG. 19, in operation S1901, a mobile device receives new data. The type of the new data may depend on the type of an application that receives the new data. For example, the new data may be a message when a message application receives the new data and may be a notice indicating an unanswered call when a phone application receives the new data.

In operation S1902, the mobile device detects a menu icon corresponding to the application that receives the new data. In this case, the mobile device may refer to a mapping table stored in a storage unit of the mobile device and in which applications and menu icons mapped to each other.

In operation S1903, the mobile device 3D renders the detected menu icon and displays a notice regarding the new data at a side of the 3D rendered menu icon. In this case, the notice of the new data displayed at the side of the 3D menu icon may include contents identifying the new data. For example, when the new data is a message, the notice of the new data may include the name of the sender of the message and a portion of the content of the message, etc.

In operation S1904, the mobile device determines whether the notice regarding the new data is selected through hovering or according to a touch input. If it is determined that the notice of the new data is selected according to the touch input, operation S1906 in which the mobile device displays a full content of the new data on the display unit is performed. If it is determined that the notice regarding the new data is selected through hovering, operation S1905 in which the mobile device displays a preview of the new data is performed. In the latter case, the mobile device may display the preview of the new data near the menu icon without switching between screens.

Referring to FIG. 20, in operation S2001, a mobile device receives new data. The type of the new data may depend on the type of an application that receives the new data. For example, the new data may be a message when a message application receives the new data or a notice indicating an unanswered call when a phone application receives the new data.

In operation S2002, the mobile device detects a menu icon corresponding to the application that receives the new data. In this case, the mobile device may refer to a mapping table stored in a storage unit of the mobile device and in which applications and menu icons mapped to each other.

In operation S2003, the mobile device 3D renders the detected menu icon and displays a notice regarding the new data at a side of the 3D rendered menu icon. In this case, the notice regarding the new data displayed at the side of the 3D menu icon may include contents for identifying the new data. For example, when the new data is a message, the notice regarding the new data may include the name of the sender of the message, a portion of the content of the message, etc.

In operation S2004, the mobile device determines whether the notice regarding the new data is touched to be selected. If it is determined that the notice regarding the new data is touched, operation S2005 in which the mobile device determines whether the notice regarding the new data is continuously touched for a predetermined period is performed.

If it is determined in operation S2005 that the notice regarding the new data is continuously touched for the predetermined period, operation S2006 in which the mobile device displays a preview of the new data is performed. However, if it is determined in operation S2005 that the notice regarding the new data is not continuously touched for the predetermined time, operation S2007 in which the mobile device displays the full content of the new data on a screen thereof is performed.

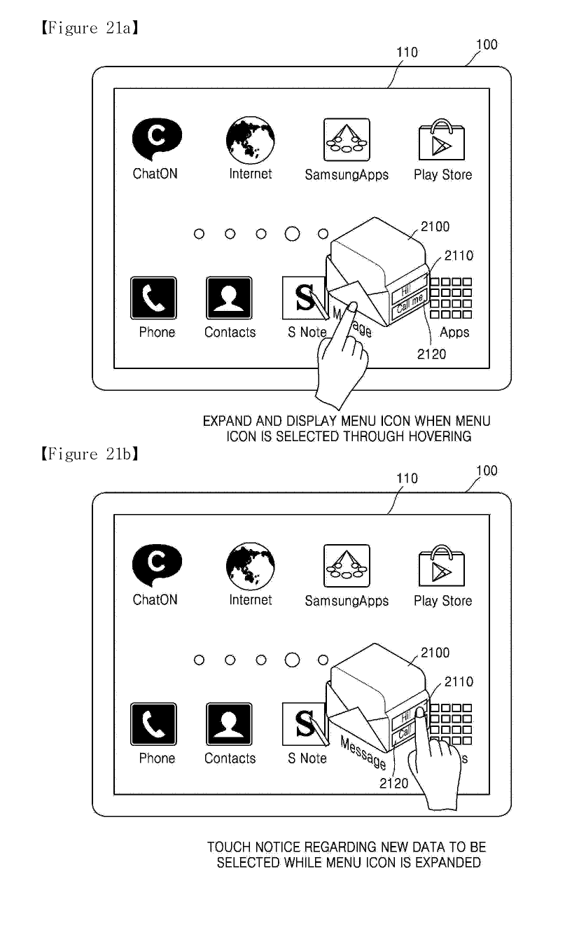

FIGS. 21A to 21C are diagrams illustrating a method of expanding a 3D menu icon and selecting a notice regarding new data displayed at a side of the 3D menu icon according to an exemplary embodiment.

Referring to FIG. 21A, menu icons corresponding to applications are displayed on a display unit 110 of a mobile device 100, a menu icon 2100 corresponding to a message application among the menu icons is 3D rendered and displayed, and notices 2110 and 2120 regarding new messages are displayed at a side of the menu icon 2100.

When a user selects the menu icon 2100 through hovering, the menu icon 2100 is expanded and displayed. Thus, the user may more exactly check the notices 2110 and 2120 regarding the new messages displayed at the side of the menu icon 2100 and easily select one of the notices 2110 and 2120.

Referring to FIG. 21B, the user may select one of the notices 2110 and 2120 regarding the new messages displayed at the side of the menu icon 2100 when the menu icon 2100 is expanded. Referring to FIG. 21B, when the notice 2110 regarding the new message is touched to be selected, a full content of the new message corresponding to the notice 2110 may be displayed on a screen as illustrated in FIG. 21C.

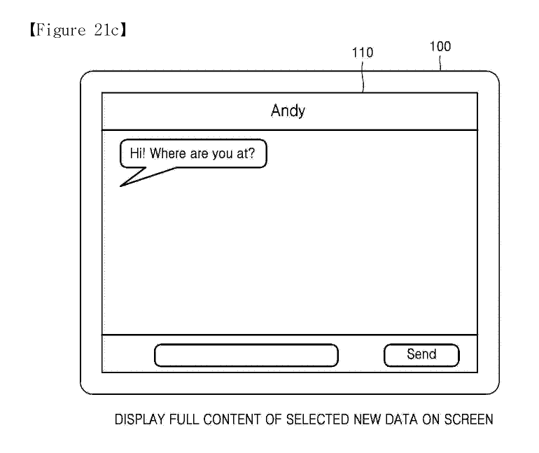

FIG. 22 is a flowchart illustrating a method of expanding a 3D menu icon and selecting a notice regarding new data displayed at a side of the 3D menu icon according to an exemplary embodiment.

Referring to FIG. 22, in operation S2201, a mobile device receives new data. The type of the new data may depend on the type of an application that receives the new data. For example, the new data may be a message when a message application receives the new data or a notice indicating an unanswered call when a phone application receives the new data.

In operation S2202, the mobile device detects a menu icon corresponding to an application that receives the new data. In this case, the mobile device may refer to a mapping table stored in a storage unit of the mobile device and in which applications and menu icons mapped to each other.

In operation S2203, the mobile device 3D renders the detected menu icon and displays a notice regarding the new data at a side of the 3D rendered menu icon. In this case, the notice regarding the new data displayed at the 3D menu icon may include contents identifying the new data. That is, when the new data is, for example, a message, the notice indicating the new data may include the name of the sender of the message, a portion of the content of the message, etc.

In operation S2204, the mobile device determines whether the 3D rendered menu icon is selected through hovering. If it is determined that this menu icon is selected through hovering, operation S2205 in which the mobile device expands and displays the selected menu icon is performed. If it is determined that this menu icon is not selected through hovering, operation S2206 is performed.

In operation S2206, the mobile device determines whether the notice regarding the new data is touched to be selected. If it is determined that the notice regarding the new data is touched, operation S2207 in which the mobile device displays the full content of the new data is performed.

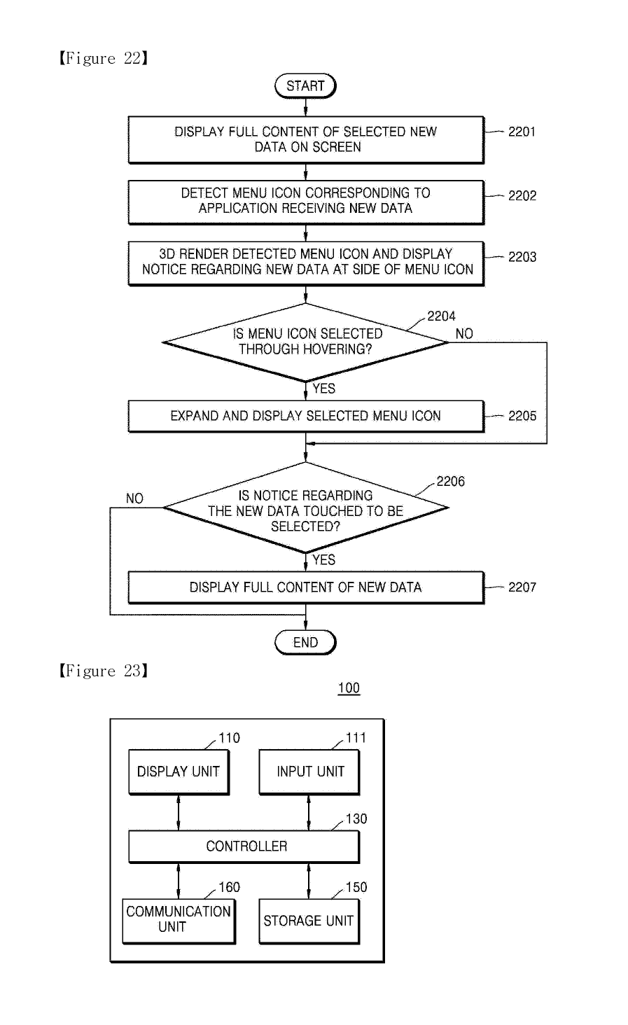

FIG. 23 is a block diagram of a mobile device 100 according to an exemplary embodiment.

Referring to FIG. 23, the mobile device 100 according to an exemplary embodiment may include a display unit 110, an input unit 111, a controller 130, a storage unit 150, and a communication unit 160.

The display unit 110 is configured to display a UI screen including menu icons of applications, etc. and may include a liquid crystal display (LCD) panel, etc.

The input unit 111 is configured to receive a user input and may include, for example, a touch screen, a keyboard, etc.

The controller 130 is configured to control operations of various components of the mobile device 100 and may include a processor, a central processing unit (CPU), etc. In the exemplary embodiments described above with reference to FIGS. 17A to 22, the controller 130 may perform determination and rendering and request the display unit 110 to display a UI screen.

In detail, the controller 130 detects a menu icon corresponding to an application that receives new data, 3D renders the detected menu icon, displays the 3D rendered menu icon on the display unit 110, and displays a notice regarding the new data at a side of the 3D rendered menu icon.

Also, the controller 130 may analyze the type of a user input received via the input unit 111 and control a UI screen displayed on the display unit 110. For example, when the input unit 111 is a touch screen, a full content of or a preview of the new data may be displayed or the menu icon may be expanded and displayed according to whether a user input for selecting the menu icon or the notice regarding the new data is a touch input or a hovering input or according to a duration of a touch input.

The storage unit 150 is a space in which data is stored, and may include a memory, such as a random access memory (RAM) or a read-only memory (ROM), a hard disc drive (HDD), etc. Various data for operating the mobile device 100, and particularly, a mapping table in which applications and menu icons are mapped to each other, may be stored in the storage unit 150. When the new data is received, the controller 130 may detect the menu icon corresponding to the application receiving the new data based on the mapping table stored in the storage unit 150.

The communication unit 160 is configured to establish communication with an external server or device in a wired/wireless manner and may include a Wi-Fi module, etc. The communication unit 160 may receive new data from the external server or device.

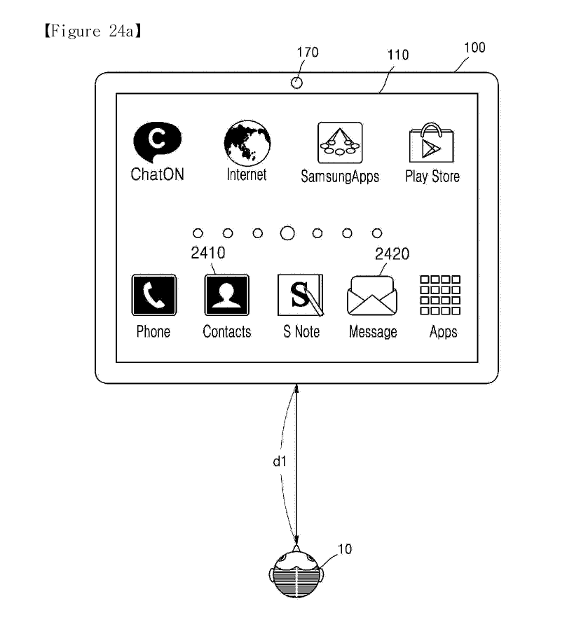

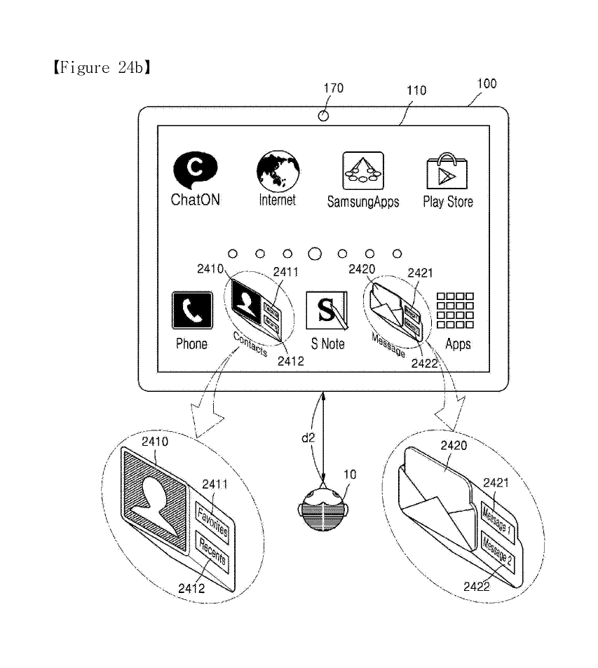

The mobile device 100 may measure the distance between the mobile device 100 and a user and change a method of displaying menu icons based on the measured distance. Methods of changing a method of displaying menu icons based on the distance between a mobile device and a user according to various exemplary embodiments will be described with reference to FIGS. 24A to 25 below.

FIGS. 24A and 24B are diagrams illustrating a method of changing a method of displaying a menu icon based on the distance between a mobile device and a user according to an exemplary embodiment.

Referring to FIG. 24A, a viewpoint sensor 120, such as a camera, measures a distance d1 between a mobile device 100 and a user 10. When the distance d1 exceeds a threshold, which is a reference value for determining whether a method of displaying menu icons is to be changed, all menu icons are two-dimensionally displayed on a UI screen displayed on a display unit 110 as illustrated in FIG. 24A. Similarly, sub-menus or menu icons 2410 and 2420 of an application that stores new data are two-dimensionally displayed.

When the user 10 approaches the mobile device 100 to reduce the distance to the mobile device 100 to be less than or equal to the threshold, the mobile device 100 changes the method of changing a method of displaying the menu icons on the UI screen. This will be described in detail with reference to FIG. 24B below.

Referring to FIG. 24B, the viewpoint sensor 120 measures a distance d2 between the mobile device 100 and the user 10, and compares the distance d2 with the threshold, which is a reference value for determining whether the method of displaying the menu icons is to be changed. If a result of the comparison reveals that the distance d2 is less than or equal to the threshold, the mobile device 100 detects the sub-menus or the menu icons 2410 and 2420 of the applications that received the new data. The mobile device 100 3D renders the detected menu icons 2410 and 2420 and displays the sub-menus or notices 2411, 2412, 2421, and 2422 regarding the new data at sides of the 3D rendered menu icons 2410 and 2420

That is, when the user 10 approaches the mobile device 100 within a predetermined distance, the user 10 may check the sub-menus of the menu icons or the new data through the 3D rendered menu icons without switching between screens.

FIG. 25 is a flowchart of a method of changing a method of displaying a menu icon based on the distance between a mobile device and a user, according to another exemplary embodiment.

Referring to FIG. 25, in operation S2501, a mobile device measures the distance between the mobile device and a user. The distance between the mobile device and the user may be measured using a camera installed in the mobile device or the like.

In operation S2502, the mobile device determines whether the measured distance is less than or equal to a predetermined value. That is, the mobile device determines whether the measured distance is less than or equal to a threshold which is a reference value for determining whether a method of displaying menu icons is to be changed.

When it is determined that the measured distance is less than or equal to the threshold, operation S2503 in which the mobile device detects a menu icon having a sub-menu or new data is performed. When it is determined that the measured distance is greater than the threshold, the method of FIG. 25 is ended.

In operation S2504, the mobile device 3D renders the detected menu icon and displays the sub-menu or a notice regarding the new data at a side of the menu icon.

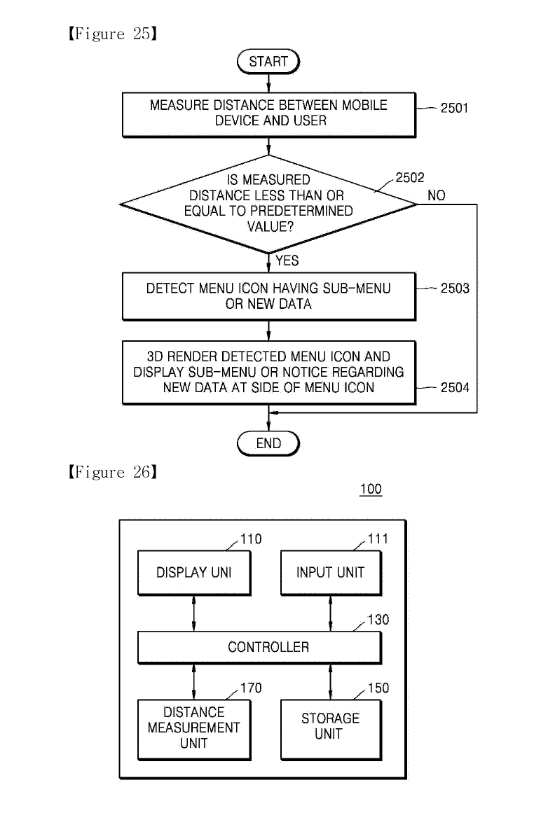

FIG. 26 is a block diagram illustrating a mobile device 100 according to another exemplary embodiment.

Referring to FIG. 26, the mobile device 100 according to another exemplary embodiment may include a display unit 110, an input unit 111, a controller 130, a storage unit 150, and a distance measurement unit 170.

The display unit 110 is configured to display a UI screen including menu icons of applications, etc., and may include a liquid crystal display (LCD) panel, etc.

The input unit 111 is configured to receive a user input and may include, for example, a touch screen, a keyboard, etc.

The distance measurement unit 170 is configured to measure the distance between the mobile device 100 and a user and may include a depth camera for measuring a distance from an object to be photographed, etc. The distance measurement unit 120 measures the distance between the mobile device 100 and the user and transmits a result of measuring the distance to the controller 130.

The controller 130 is configured to control operations of various components of the mobile device 100 and may include a processor, a CPU, etc. In the exemplary embodiments described above with reference to FIGS. 24A to 25, the controller 130 may perform determination and rendering and request the display unit 110 to display a UI screen.

In detail, the controller 130 may control rendering of menu icons displayed on the UI screen based on the result of measuring the distance received from the distance measurement unit 120. For example, the controller 130 compares the measured distance with a predetermined threshold. The predetermined threshold is a reference value for determining whether the method of displaying the menu icons is to be changed and may be set variously as necessary. When a result of the comparison reveals that the measured distance exceeds the predetermined threshold, the controller 130 controls all the menu icons on the UI screen to be two-dimensionally rendered and displayed on the display unit 110. However, when the result of the comparison reveals that the measured distance is less than or equal to the predetermined threshold, the controller 130 detects menu icons having sub-menus or new data. Then, the controller 130 3D renders the detected menu icons and displays the sub-menu or a notice regarding the new data at a side of each of the menu icons.

The storage unit 150 is used to store data and may include a memory, such as a RAM or a ROM, an HDD, etc. Various data for operating the mobile device 100, and particularly, a mapping table including applications and menu icons mapped to each other may be stored in the storage unit 150. When the measured distance is less than or equal to the predetermined threshold, the controller 130 may detect a menu icon corresponding to an application having a sub-menu or new data, based on the mapping table stored in the storage unit 150.

As described above, according to the one or more of the above exemplary embodiments, a user's viewpoint may be sensed, a 3D GUI screen may be rendered according to the user's viewpoint, and then the rendered 3D GUI screen may be displayed, thereby providing a user with a more intuitive UI experience. Also, new menus or objects may be displayed in the 3D GUI screen as the user's viewpoint changes to display more menus or objects on a screen, thereby expanding an UI. Also, the 3D GUI screen may be rendered in consideration of various states of a user such as the position of the user relative to a device, the user's gesture, etc., thereby increasing the user's intuition.

Also, when an application receives new data, a menu icon corresponding to the application may be 3D rendered and a notice regarding the new data may be displayed at a side of the menu icon. Accordingly, a user may determine whether the new data is received and check the content of the new data without switching between screens.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

1. A device comprising:
a viewpoint sensor configured to sense a user's viewpoint;
a rendering viewpoint determination processor configured to determine a rendering viewpoint according to the sensed user's viewpoint;
a rendering performing processor configured to render a three-dimensional (3D) graphical user interface (GUI) screen according to the determined rendering viewpoint; and
a display configured to display the rendered 3D GUI screen,
wherein when the user's viewpoint changes, at least one new object is additionally displayed on the rendered 3D GUI screen.

2. The device of claim 1, wherein when the user's viewpoint changes, a menu equivalent or subordinate to at least one menu displayed on the rendered 3D GUI screen before the user's viewpoint changes is expanded and displayed.

3. The device of claim 1, wherein the rendering performing processor is further configured to:
determine at least one object to be seen on the rendered 3D GUI screen from the determined rendering viewpoint, and
render the determined at least one object.

4. The device of claim 1, wherein the viewpoint sensor is further configured to measure an angle formed by the display of the device and a direction of eyes of the user.

5. The device of claim 1, wherein the rendering viewpoint determination processor is further configured to determine the rendering viewpoint based on the sensed user's viewpoint and a gesture input which is input from the user.

6. The device of claim 1, wherein the rendering performing processor is further configured to:
determine at least one new object to be added to the rendered 3D GUI screen when the user's viewpoint changes, and
render, according to the changed user's viewpoint, the 3D GUI screen to which the determined at least one new object is added.

7. An electronic device comprising:
a display configured to display a screen;
an input device configured to receive a user input;
a transceiver configured to establish communication;
a memory configured to store data; and
at least one processor configured to control an operation of the electronic device,
wherein, when new data is received via the transceiver, the least one processor is further configured to:
detect a menu icon corresponding to an application that receives the new data,
3D render the detected menu icon, and
display a notice regarding the new data at a side of the 3D rendered menu icon.

8. The electronic device of claim 7, wherein, when the notice regarding the new data is selected via the input device, the at least one processor is further configured to control the display to display a content of the new data.

9. The electronic of claim 7, wherein the at least one processor is further configured to:
determine whether an input for selecting the notice of the new data is a touch input or a hovering input,
control the display to display the full content of the new data when it is determined that the input is the touch input, and
control the display to display a preview of the new data when it is determined that the input is the hovering input.

10. The electronic device of claim 7, wherein the at least one processor is further configured to:
measure a duration for which a touch input for selecting the notice of the new data is continuously input,
compare the measured duration with a predetermined period,
control the display to display the full content of the new data when the measured duration is less than the predetermined period, and
control the display to display a preview of the new data when the measured duration is greater than the predetermined period.

11. The electronic device of claim 7, wherein, when a hovering input for selecting the 3D rendered menu icon is received via the input device, the at least one processor is further configured to control the display to expand and display the menu icon.

12. An electronic device comprising:
a display configured to display a screen;
an input device configured to receive a user input;
a memory configured to store data;
a distance measurement sensor configured to measure a distance between the electronic device and a user; and
at least one processor configured to control an operation of the electronic device,
wherein, when a distance between the electronic device and a user, which is measured by the distance measurement sensor, is less than or equal to a predetermined value, the at least one processor is further configured to:
detect a menu icon corresponding to an application having a sub-menu or new data,
3D render the detected menu icon, and
controls the display to display the sub-menu or a notice regarding the new data at a side of the 3D rendered menu icon.
